(19) United States
(12) Patent Application Publication
(10) Pub. No.: US 2013/0216981 A1
(43) Pub. Date: Aug. 22, 2013

(54) 3D PIN TACTILE DEVICE

(71) Applicants: Terry Campbell, San Antonio, TX (US); Coy DeLynn Mason, Castroville, TX (US)

(72) Inventors: Terry Campbell, San Antonio, TX (US); Coy DeLynn Mason, Castroville, TX (US)

(21) Appl. No.: 13/400,378

(22) Filed: Feb. 20, 2012

(51) Int. Cl. G09B 21/00

(52) U.S. Cl. 434/112

(57) ABSTRACT

A 3D pin tactile device has a device housing, an imaging radar operatively installed in the device housing for detecting surface contours of the object, and an array of pins mounted in a pin mounting screen. An actuation system is adapted for moving each of the array of pins such that a head of the each of the array of pins collectively match the contours of the object. In this manner, the blind person can perceive the object by feeling the heads of the array of pins.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to a sensor device for assisting a blind person, and more particularly to a 3D pin tactile device that enables a blind person to perceive an object via imaging radar.

2. Description of Related Art

It is desirable for a blind person to be able to perceive, or “view,” an object, using his or her sense of touch, without the invasive step of actually touching the object. This is particularly important when interacting with a person, such as when the blind person is talking with the person. While the blind person might want to feel the face of the person with whom they are speaking, it is undesirable to physically touch the person's face, which is a fairly invasive and perhaps overly-familiar in many circumstances.

The prior art does not teach a device that enables a blind person to perceive the object using his or her sense of touch, without physically touching the object. The present invention fulfills these needs and provides further related advantages as described in the following summary.

### SUMMARY OF THE INVENTION

The present invention teaches certain benefits in construction and use which give rise to the objectives described below.

The present invention provides a 3D pin tactile device for assisting a blind person to perceive an object. The 3D pin tactile device comprises a device housing; an imaging radar operatively installed in the device housing for detecting surface contours of the object; an array of pins mounted in a pin mounting screen, each of the array of pins having a head; and an actuation system for moving each of the array of pins such that the heads of the array of pins collectively match the contours of the object, such that the blind person can perceive the object by feeling the heads of the array of pins.

A primary objective of the present invention is to provide a 3D pin tactile device having advantages not taught by the prior art.

Another objective is to provide a 3D pin tactile device that enables a blind person to perceive an object using tactile sensory input.

A further objective is to provide a 3D pin tactile device that enables a blind person to feel contours of the object, such as the face of a person, without physically touching the person's face.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a front perspective view of a 3D pin tactile device according to one embodiment of the present invention;

FIG. 2 is a rear perspective view thereof;

FIG. 3 is a side sectional view thereof;

FIG. 4 is a block diagram thereof;

FIG. 5 is a perspective view of a blind person using the 3D pin tactile device to perceive an object;

FIG. 6 is a perspective view of the 3D pin tactile device mounted on a glove enclosure on the blind person's hand, and being used in conjunction with a sensor device mounted on a cane; and

FIG. 7 is a perspective view of the glove enclosure, illustrating the glove enclosure and a wrist strap to secure the device to the blind person's hand.

### DETAILED DESCRIPTION OF THE INVENTION

The above-described drawing figures illustrate the invention, a 3D pin tactile device for assisting a blind person to perceive an object.

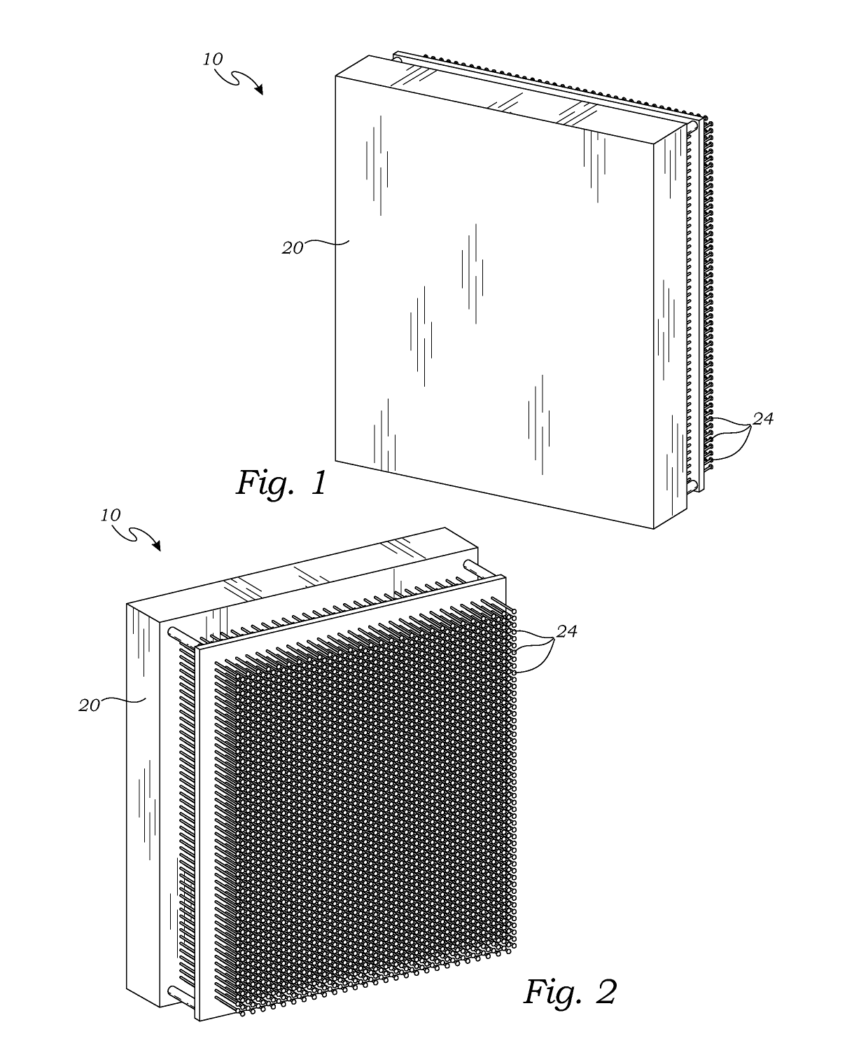

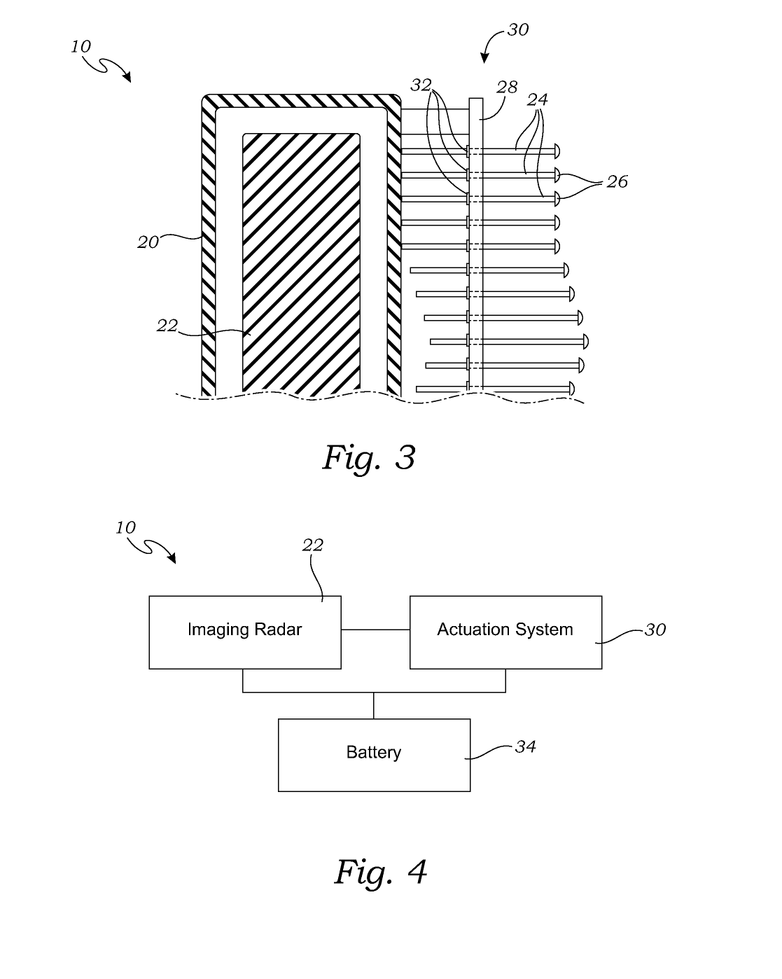

FIG. 1 is a front perspective view of the 3D pin tactile device 10 according to one embodiment of the present invention, and FIG. 2 is a rear perspective view thereof. FIG. 3 is a side sectional view of the 3D pin tactile device 10, and FIG. 4 is a block diagram thereof.

As illustrated in FIGS. 1-4, the 3D pin tactile device 10 comprises a device housing 20 and an imaging radar 22 operatively installed in the device housing 20. In the present embodiment, the device housing 20 is a generally cuboid structure constructed of sturdy, lightweight material (e.g., plastic). The imaging radar 22 is operatively installed in the device housing 20 and is disposed within the device housing 20 for detecting surface contours of the object when the 3D pin tactile device 10 is held in front of the object.

The 3D pin tactile device 10 further includes an array of pins 24 mounted in a pin mounting screen 28. The array of pins 24 area arranged in close proximity to each other, and each of the array of pins 24 has a head 26. The head 26 may be rounded to provide a smooth and pleasant tactile surface. The heads 26 are preferably close to one another so that they collectively can provide a fairly continuous surface.

An actuation system 30 is included for moving each of the array of pins 24 such that the heads 26 of the array of pins 24 collectively match the contours of the object, such that the blind person can perceive the object by feeling the heads 26 of the array of pins 24.

The actuation system 30 may be provided by any form of control system, actuators 32, or other means of moving the pins responsive to the imaging radar 22. In the embodiment of FIGS. 1-4, the actuation system 30 includes a plurality of mechanical actuators 32, each being operatively connected with one of the array of pins 24 for moving the pin responsive to the imaging radar 22. The actuation system 30 may further include a battery 34 for powering the actuation system 30, as well as various computer control components (e.g., controllers, memory, etc.), not illustrated herein, for operatively controlling the actuators 32. In another embodiment, the actuation system 30 includes a plurality of magnetic actuators 32 is operatively positioned adjacent one of the array of pins 24 for magnetically moving the pin to its proper location. Those skilled in the art may devise a range of mechanisms for moving the pins as described in the present specification, and such alternatives and equivalents should be considered within the scope of the present invention.

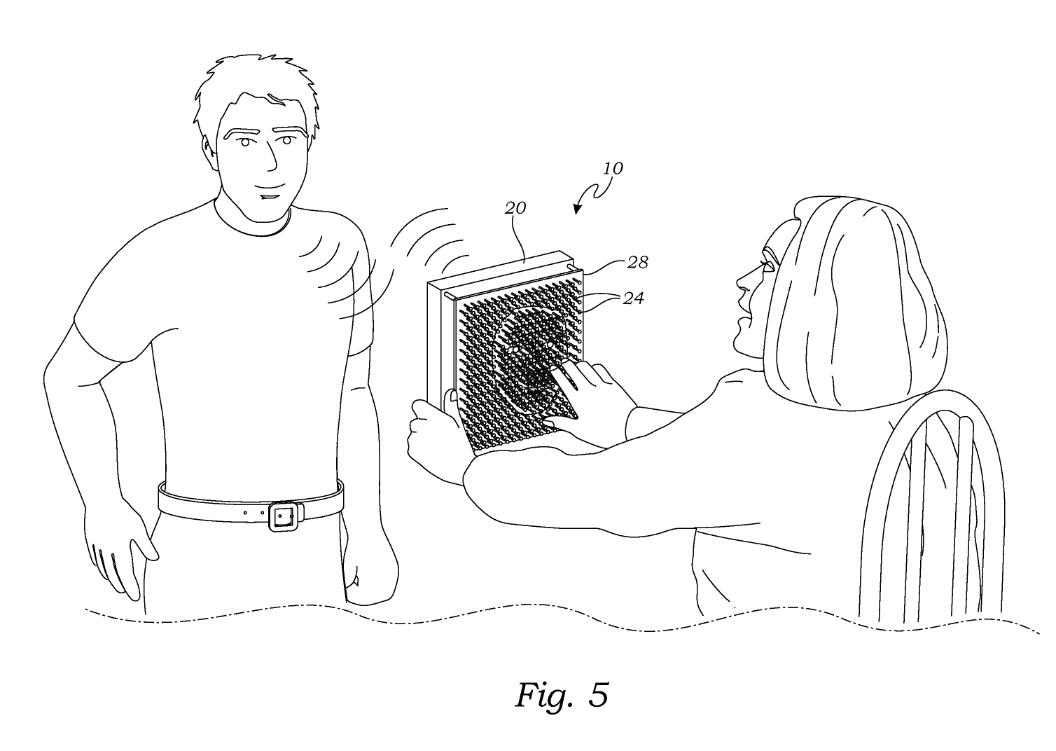

FIG. 5 is a perspective view of a blind person using the 3D pin tactile device 10 to perceive the object. As illustrated in FIG. 5, the blind person holds the 3D pin tactile device 10 in front of the object, in this case a person, so that the imaging radar 22 can be directed towards the object. The imaging radar 22 captures the contours of the object as image data, in this case the facial features of the person, and transmits the image data to the actuator system. The actuator system actuates the pins, moving them so that the heads 26 of the pins correspond with the contours of the object.

The blind person can then touch the heads 26 of the pins, and feel the contours, thereby perceiving the contours of the object. The blind person is thereby able to “see” the object, using tactile sensations. It is particularly desirable to use the device when the object is a person, so that the blind person can “see” the person with whom he or she is interacting. Via the 3D pin tactile device 10 it is possible to “see” the person without the somewhat invasive alternative of touching the person's actual face.

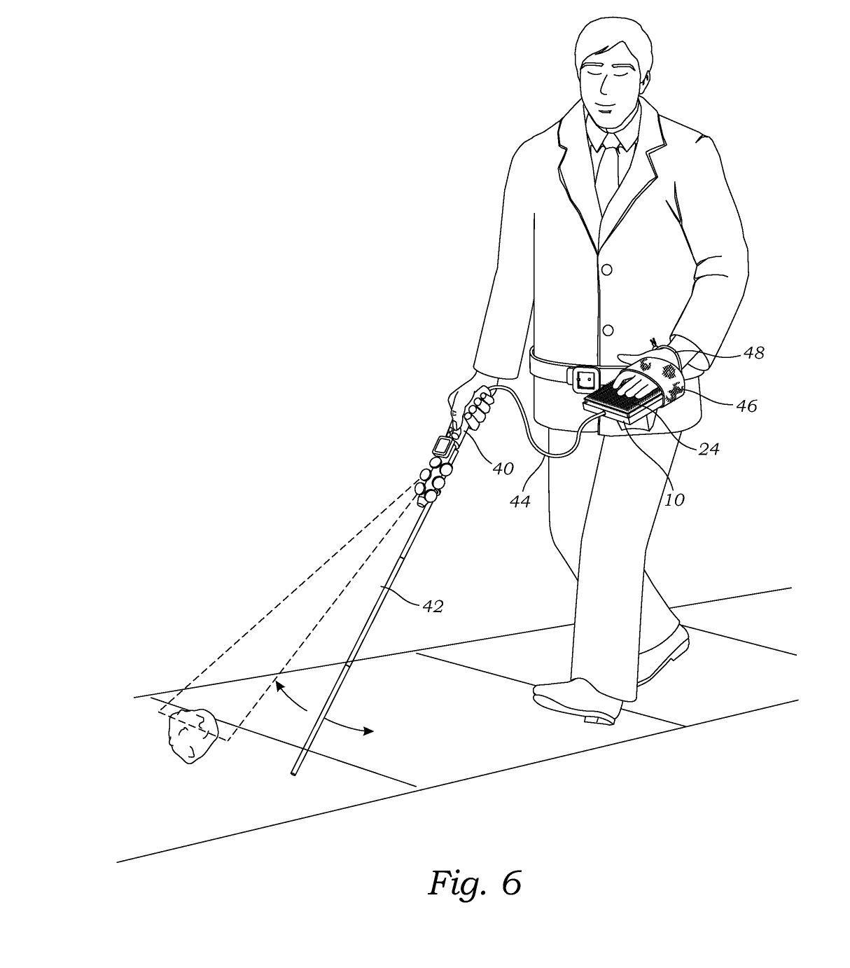

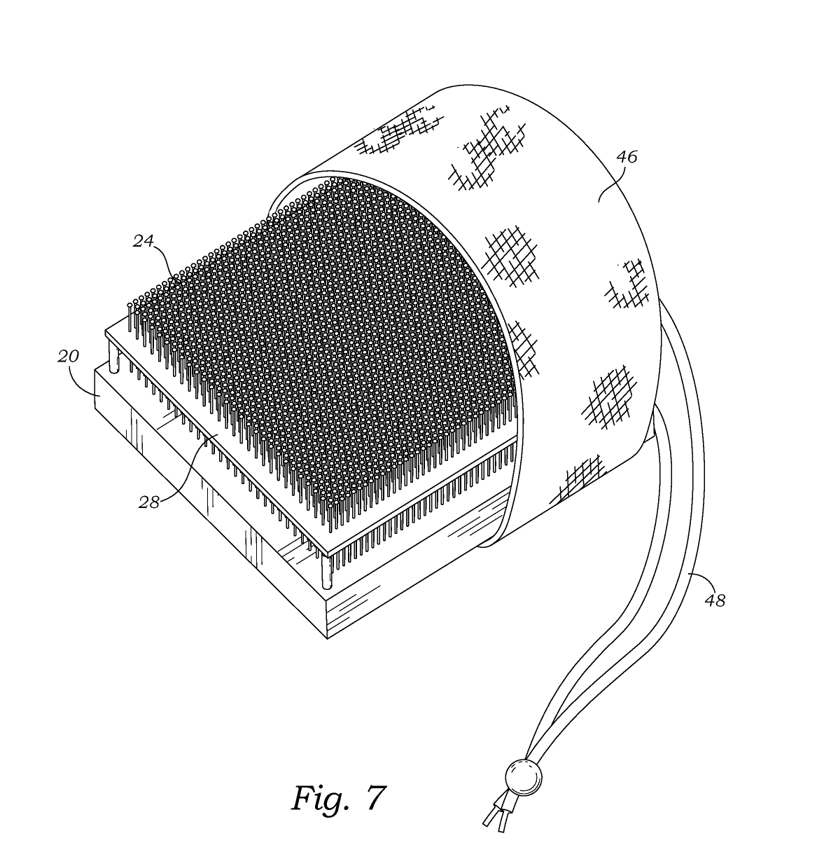

FIG. 6 is a perspective view of a glove enclosure 46 mounted on the 3D pin tactile device 10 worn over the blind person's hand, and being used in conjunction with a sensor device 40 mounted on a cane 42. In the embodiment of FIG. 6, the glove enclosure 46 is attached to the hand of the blind person, and mounts to the 3D pin tactile device 10 for supporting the 3D pin tactile device 10 in an orientation for use. A data cable 44 may be used to interconnect the 3D pin tactile device 10 and the sensor device 40 of the cane 42, or alternatively, a wireless connection may be used, or any other form of data connection know in the art.

The sensor device 40 mounted on the cane 42 may be of the type discussed in Campbell, U.S. Pat. No. 7,706,212, which is hereby incorporated by references. In alternative embodiments, other detection devices known in the art may also be utilized.

FIG. 7 is a perspective view of the glove enclosure, illustrating the glove enclosure 46 and a wrist strap 48 to secure the device to the blind person's hand. The glove enclosure 46 may include any form of strap, glove element, band, or housing that allows the blind person to fasten the 3D pin tactile device 10 to his or her hand so that he or she may be able to readily distinguish the contours of the array of pins 24. It may further include the wrist strap 48 to further secure the 3D pin tactile device 10 and the glove enclosure 46 to the blind person's hand to prevent slippage and minimize damage if the 3D pin tactile device 10 falls off of the blind person's hand.

In operation, the blind person mounts the 3D pin tactile device 10 onto the glove enclosure 46 to be worn over his or her hand, secured by the wrist strap 48. The device 10 is then interconnected with the sensor device 40 mounted on his or her cane (e.g., connecting with the data cable 44 or otherwise). The blind person is then able to walk using the cane 42, as usual, and perceive the terrain in front of him/her using the 3D pin tactile device 10.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A 3D pin tactile device for assisting a blind person to perceive an object, the 3D pin tactile device comprising:
a device housing;
an imaging radar operatively installed in the device housing for detecting surface contours of the object;
an array of pins mounted in a pin mounting screen, each of the array of pins having a head; and
an actuation system for moving each of the array of pins such that the heads of the array of pins collectively match the contours of the object, such that the blind person can perceive the object by feeling the heads of the array of pins.

2. A 3D pin tactile device for assisting a blind person to perceive an object, the 3D pin tactile device comprising:
a device housing;
an imaging radar operatively installed in the device housing for detecting surface contours of the object;
an array of pins mounted in a pin mounting screen, each of the array of pins having a head;
an actuation system for moving each of the array of pins such that the heads of the array of pins collectively match the contours of the object, such that the blind person can perceive the object by feeling the heads of the array of pins; and
a glove enclosure mounted on the 3D pin tactile device for fastening the device on the blind person's hand.

3. The 3D pin tactile device of claim 2, wherein the glove enclosure is a strap that fits around the hand of the blind person.

4. The 3D pin tactile device of claim 3, wherein the glove enclosure further includes a wrist strap for securing the 3D pin tactile device on the blind person's hand.
